(19) United States
(12) Patent Application Publication
(10) Pub. No.: US 2017/0083157 A1
(43) Pub. Date: Mar. 23, 2017

(54) PROJECTION DEVICE

(71) Applicant: Anthrotronix, Inc., Silver Spring, MD (US)

(72) Inventors: Jack M. Vice, Orlando, FL (US); Corinna E. Lathan, Wheaton, MD (US); Joli Rightmyer, Arlington, VA (US); Sanjay Mishra, North Potomac, MD (US)

(73) Assignee: Anthrotronix, Inc., Silver Spring, MD (US)

(21) Appl. No.: 15/272,368

(22) Filed: Sep. 21, 2016

Related U.S. Application Data
(60) Provisional application No. 62/221,312, filed on Sep. 21, 2015.

(51) Int. Cl. G06F 3/041; G06F 3/042

(52) U.S. Cl. CPC G06F 3/0418; G06F 3/0425

(57) ABSTRACT

Embodiments relate to a portable device that is configured to project an image onto a secondary surface, and to support interaction with the projected image. The device is configured with an embedded projector to display indicia on a secondary surface. More specifically, the projector is configured to project an interactive image onto a secondary surface. The device is employed to communicate and interact with one or more components displayed within the image. Data related to the interaction is acquired by the device and stored local to the device or communicated to a secondary device.

### CROSS REFERENCE TO RELATED APPLICATION(S)

This application is a non-provisional patent application claiming the benefit of the filing date of U.S. Patent Application Ser. No. 62/221,312 filed on Sep. 21, 2015 and titled “Projector Stylus” which is hereby incorporated by reference.

### BACKGROUND

The present embodiments relate to projecting an image onto a secondary surface from a portable projection device. More specifically, the embodiments relate to interacting with the projected image as displayed on the secondary surface.

A common form of a computer input device functions as an instrument to draw images or select one or more image from a menu on a touch sensitive visual display. One or more actions are performed by a processing unit in communication with the display based on the location of a touch received and sensed by the display, as well as the number of touches. Accordingly, the device communicates with the processing unit through physical interaction and touch with the associated visual display.

Various forms of portable computing apparatus are known, including laptop computers, tablet computers, and handheld telecommunication devices, also referred to herein as smartphones. Each of these apparatus may be configured with a touch sensitive visual display. Data is presented on the display, and input with the apparatus is received through direct interaction with the visual display, such as a direct touch with the visual display or touch via a device. Accordingly, these computing apparatus are configured with a visual display configured to receive a form of direct input to an associated processing unit.

### SUMMARY

A system, computer program product, and method are provided for projecting an image onto a secondary surface from a portable projection device and supporting interaction with the projected image

In one aspect, a method is provided for projecting an image onto a secondary surface and supporting interaction with the projected image. An image is received which is to be projected onto a secondary surface. A distance is measured between the projection origination and the secondary surface, and an orientation of the projection origination is measured with respect to the secondary surface. Image geometry and image location in a projection area proximal to the secondary surface are calculated. The calculation includes a correction to the geometry of the image, if any. The correction is applied and results in creation of a corrected image and an associated corrected image projection on the secondary surface.

In another aspect, a computer system is provided with a processing unit in communication with memory configured to receive an image to be projected onto the secondary surface. A rangefinder and an orientation unit are operatively coupled to the processing unit. The rangefinder is configured to measure a distance between the projection origination and the secondary surface. The orientation unit is configured measure orientation data of the projection origination. In addition, a tool is provided in communication with the processing unit. The tool calculates image geometry and image location with respect to a projection area proximal the secondary surface. More specifically, the calculation is based on the measured orientation of the projection and measured distance. Additionally, a correction, if present, to the geometry of the image is calculated. The correction is applied to the image to create a corrected image. The image is projected onto the secondary surface by a projector which is operatively coupled to the processing unit.

In yet another aspect, a computer program product is provided for projecting an image and supporting interaction with the projected image. The computer program product includes a computer readable storage device embodied with program code that is configured to be executed by a processing unit. More specifically, program code is provided to receive an image to be projected onto a secondary surface. Additionally, a distance between the projection origination and the secondary surface and an orientation of the projection origination with respect to the secondary surface is measured. The measured orientation and measured distance are used to calculate image geometry and image location in the projection area proximal to the secondary surface. The calculation includes a correction to the geometry of the image. A corrected image is created by application of the correction and projected onto the secondary surface.

Other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments unless otherwise explicitly indicated.

FIG. 1 depicts a block diagram illustrating physical components embedded in a body to support the functionality of image projection from the device and projection of the image onto a secondary surface.

FIG. 2 depicts a block diagram illustrating a device for projecting an image and interacting with the projected image.

FIG. 3 depicts a flow chart illustrating a process for projection of an image from the device onto a secondary surface and resolving and/or correcting distortion of the projected image view.

FIG. 4 depicts a flow chart illustrating a process for interacting with the projected images.

FIG. 5A depicts a block diagram illustrating an example of a device projecting an image and interaction with the projected image in an initial state.

FIG. 5B depicts a block diagram illustrating an example of a device projecting an image and the interaction with the projected image in a second state.

FIG. 6 depicts a flow chart illustrating one aspect of assessing cognitive efficiency using the device and its functionality.

FIG. 7 depicts a flow chart illustrating a process for comparison of reaction times based on the sequential administration of tests.

FIG. 8 depicts a flow chart illustrating a process for employing a cognitive metering device with assessment data.

FIG. 9 depicts a flow chart illustrating a process for calibrating or re-calibrating the metering device.

FIG. 10 depicts a flow chart illustrating a process for supporting interaction with the portable projection device, with the interaction affecting the state of operation of the device.

FIG. 11 depicts a block diagram illustrating hardware components for implementing the functionality of the calibration device.

FIG. 12 depicts an illustrative example of a cloud computing environment, in accordance with an embodiment.

FIG. 13 depicts an illustrative example of abstraction model layers, in accordance with an embodiment.

### DETAILED DESCRIPTION

It will be readily understood that the components of the present embodiments, as generally described and illustrated in the Figures herein, may be arranged and designed in a wide variety of different configurations. Thus, the following detailed description of the embodiments of the apparatus, system, and method, as presented in the Figures, is not intended to limit the scope, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

A portable projection device, hereinafter “device,” is provided embedded in an apparatus, such as a stylus or similarly configured device. More specifically, the device is configured with an embedded projector to display indicia on a secondary surface. In one embodiment, the indicia may be in the form of an image, text, or combinations thereof. In one embodiment, the surface is a matte surface having a light color property. Similarly, in one embodiment, the surface is non-virtual and non-transparent and has a surface configured with a property to reflect an image. The projector is configured to project an interactive image onto a secondary surface. More specifically, the device is employed to communicate and interact with one or more components displayed within the image. Data related to the interaction is acquired by the device and stored local to the device or communicated to a secondary device.

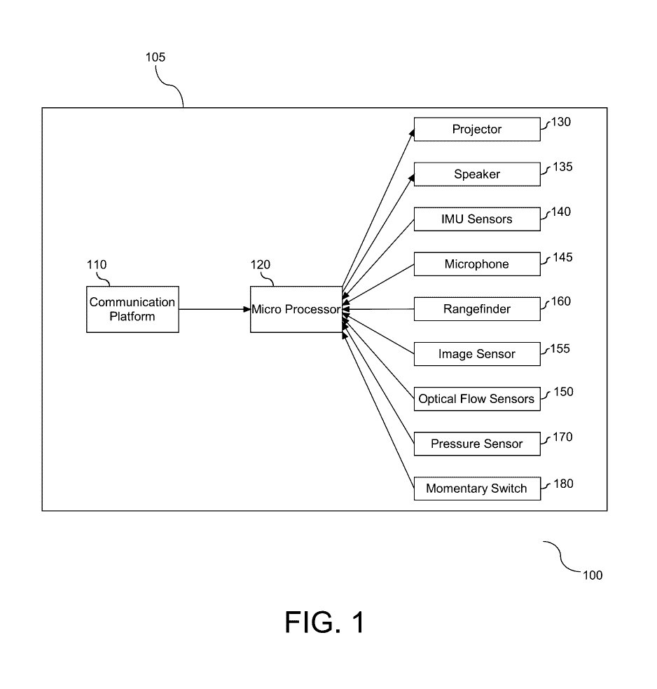

Referring to FIG. 1, a block diagram (100) is provided illustrating physical components embedded in a device body (105), hereinafter referred to as “body,” to support the functionality of image projection from the device and projection of the image onto a secondary surface described herein. A communication platform (110) is shown in communication with a microprocessor (120). The communication platform (110) supports communication between the device and any secondary element configured to receive communication. In one embodiment, the communication is wireless and the secondary element may be a wireless network or a computer. This communication platform (110) enables data from the device to be received by a secondary element. At the same time, this communication platform (110) enables the secondary element to communicate with device, such as to update assessment protocols. As will be described in detail below, data associated with interaction with the projected image may be acquired and stored local to the device or in a remote storage device via the communication platform (110). In one embodiment, the communication platform (110) may leverage the functionality of shared resources in a cloud computing environment to enhance the functionality of the assessments and associated data.

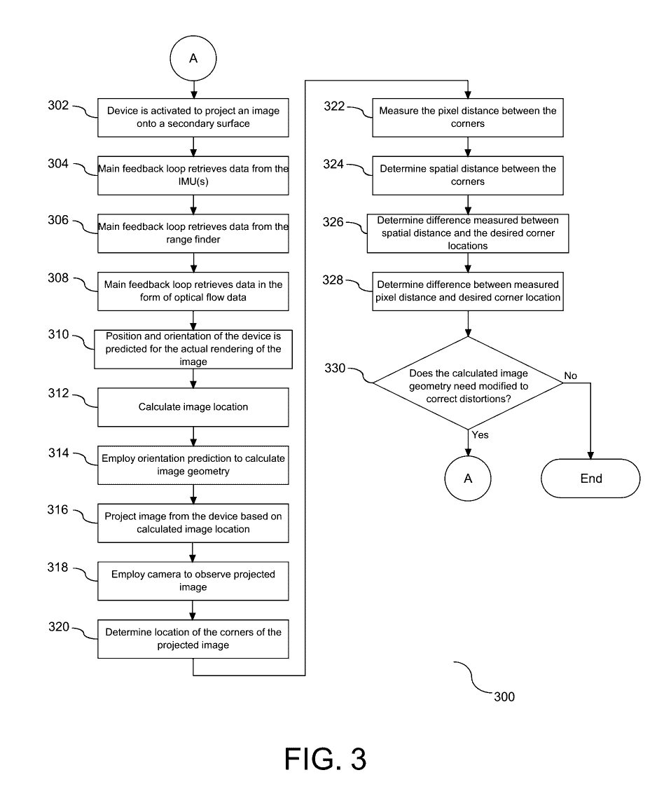

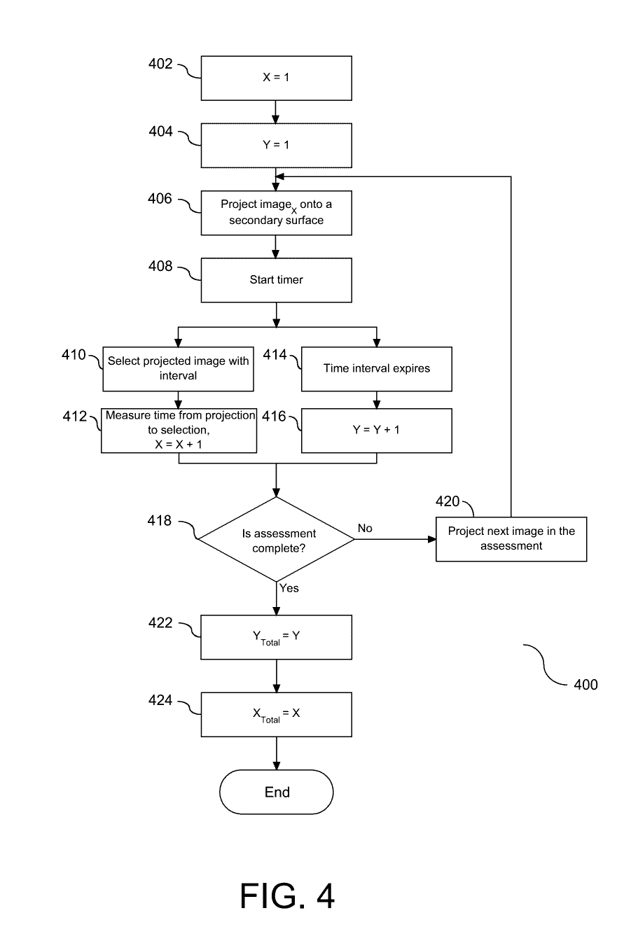

The microprocessor (120), or in one embodiment a processor, is shown to interface with the communication platform (110) and elements that support and enable operation of the device. The processor (120) communicates with a projector (130) to transmit an image to a secondary surface. In one embodiment, the projector is a micro-projector. Similarly, in one embodiment, the projector employs circuitry and supporting hardware. The projector (130) functions as a display component to project an image as generated from the processor (120) onto a display or a secondary surface. As shown and described in FIGS. 3 and 4 below, an assessment protocol is embedded within the elements and the projector (120) projects an image associated with the assessment protocol onto a secondary surface. In one embodiment, the device may be employed to project alternative protocols, and as such, should not be limited to the assessment protocols shown and described herein. Accordingly, the device permits projection of images on a secondary surface or display for use and associated interaction.

The body (105) that contains the hardware described herein is portable and as such is subject to movement. In order to track orientation and movement of the body (105), one or more orientations units are provided embedded in the body (105) and in communication with the processor (120). An orientation unit may be in the form of an inertial measurement unit (IMU) (140), which is an electronic device that measures and reports acceleration, rotation, orientation, magnetic and gravitational forces on the body (105) to the processor (120) using a combination of accelerometers, and gyroscopes, and in one embodiment magnetometers. For descriptive purposes, the orientation unit is described in the manner of the IMU (140). Data collected from the IMU(s) (140) enables the processor (120) to track orientation and movement of the body (105). Accordingly, data pertaining to the orientation and position of the body (105) is communicated to the processor (120) to enable tracking of orientation and movement of the body (105).

Additionally, as shown, one or more optical data flow sensors (150) and a rangefinder (160) are provided in communication with the processor (120). Data from both the optical flow sensors (150) and the rangefinder (160) is communicated to the processor (120) which employs this data to facilitate projection of an image on to the secondary surface. The optical flow sensors and rangefinder provide location data of the device with respect to a secondary surface which may be used to correct display of the projected image. In one embodiment, the optical flow sensor(s) detects two dimensional movement of the body (105) and the rangefinder (160) detects a third dimension of the movement. In one embodiment, the rangefinder (160) is directly correlated with the field of view of the projected image. In one embodiment the optical flow sensor is a camera or other image sensor (155). In one embodiment, the range finder may be, but is not limited to, infrared, laser, sonic, stereo camera, or other type of distance calculating device. In one embodiment, an orientation unit includes an accelerometer to provide orientation data. In one embodiment, an orientation unit may be composed of a combination of tools, including but not limited to one or more optical flow sensors, accelerometers, gyroscopes and magnetometers and IMU. Accordingly, the optical flow sensors and range finder are used to address movement of the device and correct display of the projected image associated with such movement.

As shown, the processor (120) is in communication with a pressure sensor (170), which may be employed as one aspect to interact with the projected image. As described herein, the image is projected from the projector (130) onto a secondary surface. In order to facilitate or otherwise enable interaction with one or more projected image(s), the pressure sensor (170) is provided in communication with the processor (120) to communicate physical contact between the body (105) and the secondary surface. An indication that the body is touching the secondary surface is when data from the pressure sensor (170) exceeds a threshold. The time at which the data from the pressure sensor (170) exceeds the threshold indicates the general time of physical contact with the secondary surface. Accordingly, the pressure sensor provides one manner of interaction with the one or more projected image(s).

Additionally, the IMU (140) can facilitate or otherwise enable interaction with one or more projected images. The IMU (140), as stated above, detects acceleration, e.g. the moment the body starts moving and stops moving. The acceleration data reported by the IMU (140) indicates the moment of physical contact, thereby determining the time of the highest value of negative acceleration, e.g. deceleration, associated with the physical contact. In one embodiment, when the data from the pressure sensor (170) exceeds a threshold, the data from the IMU (140) may work in tandem with the pressure sensor data to report a more accurate result. Additionally, the IMU sensor(s) (140), optical flow sensor(s) (150), rangefinder (160), and pressure sensor (170) all transmit data to the processor (120), which transmits output in the form of an image to the projector (130) and/or communicates to a secondary receiving device. Accordingly, the processor (120) is configured to receive data from a plurality of sensors and external device(s) to support image projection and interaction.

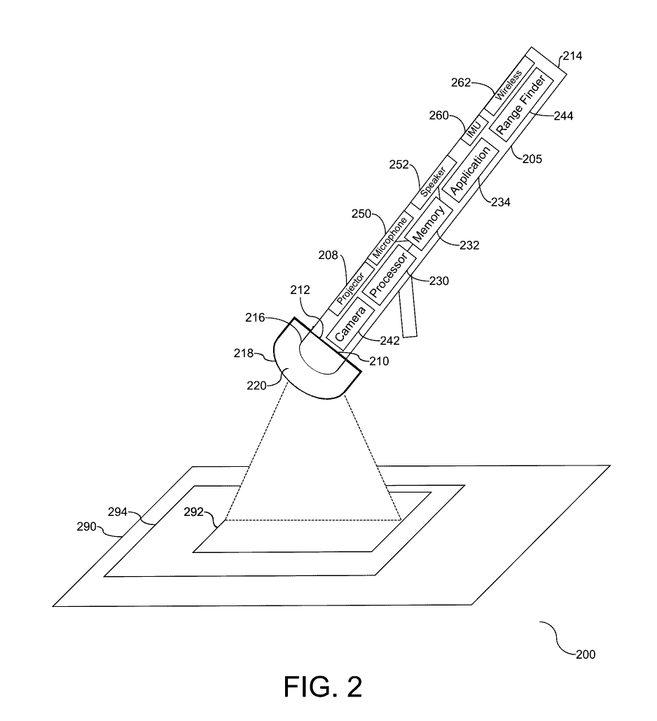

As shown, a speaker (135) and a microphone (145) are provided in communication with the processor (120). The microphone (145) is configured to receive voice data, and the speaker (135) is configured to project voice data. The functionality of the speaker (135) and microphone (145) is described in detail in FIG. 2 below.

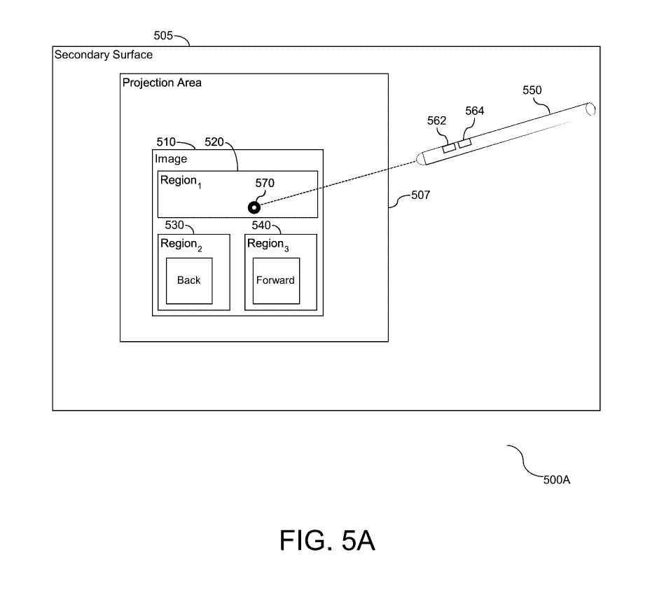

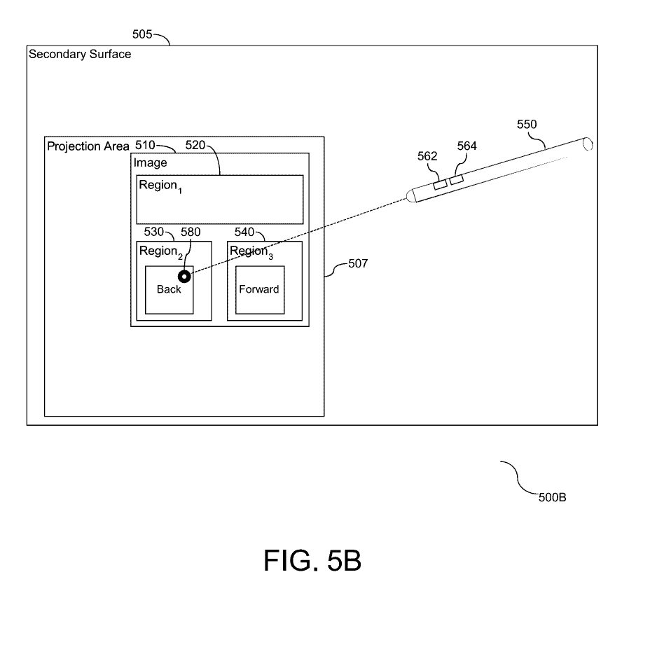

In addition to or separate from the pressure sensor (170), one or more momentary switches (180) are provided in communication with the processor (120). The switch(es) (180) functions to facilitate interaction with the projected image(s). Use of the switch(es) (180) enables interaction with the projected image(s) from a defined distance. In one embodiment, use of the switch(es) (180) is an alternative or additional tool to interact with the projected image. The switch(es) (180) enables the user to interact with the projected image without direct contact or communication with the secondary surface. For example, in one embodiment, when an image is projected and stabilized on the secondary surface, the device may enter into an image interaction mode. In this mode, a pointer in the form of a cursor is rendered in direct alignment with the device in the projection area. The pointer, e.g. cursor, may be directed to a specific area of the projected image, and engagement of the switch(es) (180) functions as a selection of the area designated by the pointer e.g. cursor. Details of the functionality of the pointer or cursor are shown and described in FIGS. 5A and 5B. In addition, an example of the projected image and use of the pointer, e.g. cursor, together with the switch is shown and described in FIG. 5B. Accordingly, the use of the pointer, e.g. cursor, together with the switch(es) enables the device to enter an image interaction mode whereby the pointer, e.g. cursor, may be directed to a specific area of the projected image by orientating or moving the body of the device, and the switch(es) (180) may be actuated as a selection or designation of the specific area of the projected image.

Referring to FIG. 2, a block diagram (200) is provided illustrating a device for projecting an image and interacting with the projected image. The device is shown with a body (205) housing the processor and sensors shown and described in FIG. 1. The body (205) shown and described herein represents an elongated and relatively thin shape, and in one embodiment such as that of an alternative writing implement. In one embodiment, the body (205) may take on a different size and shape, and as such the body shown and described herein should not be considered limiting. Accordingly, the body (205) has a shape that is able to receive the elements for projecting and interacting with an image.

As shown, the body (205) is provided with a pressure sensor (210) located or in communication with an external surface of the body (205). The pressure sensor (210) is in communication with the processor (230) and is configured to detect pressure data associated with exerting pressure associated with the body (205) onto a secondary surface (290). More specifically, the secondary surface (290) is not a part of the body (205), and is not specifically configured to communicate with the body (205). The secondary surface (290) can be any surface that receives an image projected from the body (205). Accordingly, the secondary surface (290) does not have to be a specially configured visual display that is sensitive to touch.

The body (205) is shown herein in an elongated form with two oppositely disposed ends, including a proximal end (212) and a distal end (214). The proximal end (212) is provided with a lens (216) though which an image is projected onto the secondary surface (290) within the available projection area (294). The lens (216) is shown herein with a cover (218) to enclose the lens (216). In one embodiment, the cover is a glass hemisphere with a gap (220) formed between the lens (216) and a surface of the cover (218). The gap (220) functions to allow light to project the image from the lens (216). In addition, the pressure sensor (210) is provided in communication with or adjacently position to the lens (216). As the body (205) may be configured to contact the secondary surface (290), and associated contact data is relevant to interaction with the projected image (292), the sensor (210) is positioned relative to the projection of the image from the body (205). When data from the pressure sensor (210) exceeds a threshold, this is an indication that the pressure sensor (210) has been activated by the body of the device touching the secondary surface (290). In one embodiment, the pressure sensor (210) is configured to select an image projected on a secondary surface that is not physically connected to the body (205). Accordingly, the selection is based upon the actuation of the pressure sensor (210) within the perimeter or confines of the projected image (292) projected within the projection area (294).

The projector (208) projects an image through the lens (216) onto the secondary surface (290) within the available projection area (294). In one embodiment, the projected image (292) is a magnified form of the image. In one embodiment, the lens (216) is chosen based on a predetermined field of view required, and in one embodiment a fisheye lens may be chosen to provide a large field of vision. Additionally, a camera (242) is provided in communication with the lens (216). The camera (242) functions to measure and map the secondary surface (290) to enable geometric correction for any irregularities in the surface (290). In one embodiment, the camera, or an image sensor, is offset (242) from the projector (208), which in one embodiment supports detection of any irregularities with respect to the secondary surface and correction of an associated image projection. As articulated above, the secondary surface (290) can be an external surface of any secondary object, and as such does not have to be specifically configured to display an interactive image. Accordingly, the image projected through the lens (216) onto the secondary surface (290) is an interactive image and the projected image enables and facilitates a bi-directional flow of data between a processor (230) embedded within the body (205) and an element communicating with the projected image, such as the pressure sensor (210), and in one embodiment the projected image responding to the interaction.

As shown in FIG. 2, the body (205) is in communication with an embedded processor (230) and operatively coupled to memory (232). One or more IMU(s) (260) are provided embedded within the body (205) and functions in communication with the processor (230) to measure and report movement, acceleration, orientation, and gravitational forces of the body (205). In one embodiment, the IMU(s) (260) use a combination of accelerometers and gyroscopes, and/or magnetometers. The IMU(s) (260) detect the current rate of acceleration and detect changes in rotational attributes, such as roll, pitch, and yaw. Accordingly, IMU(s) in communication with the processor detect orientation and movement of the body.

As shown, one or more applications (234) are provided in memory (232) within the body (205). Each application (234) may be executed by the processor (230). The application(s) (234) includes an associated interactive interface that is configured to display data in the form of an image or a sequence of images projected onto a secondary surface (290). At the same time, the application (234) is configured to receive data associated with user inaction with or within the image. Different aspects of the displayed image (292) may be selected by the device displaying the image, or in one embodiment an alternative selection device. Data based on the orientation and position of the device body and the camera (242) facilitate determining if the selection associated with the pressure sensor (210) is within the confines of the projected image. In one embodiment, the accelerometer component of the IMU (260) adds accuracy to the selection time interval pertaining to the confines of the projected image (292). Data associated with the selection is received by the display device or the alternative selection device. In response to the received data, the projected image (292) displayed on the secondary surface (290) may change so that a different image is displayed. Accordingly, the camera, IMU and optical flow sensor is in communication with the processor to track user interaction with a projected image.

In one embodiment, a rangefinder (244) is operatively coupled to the processor (230) and functions to adjust the field of view. The rangefinder (244) functions as to provide a distance measurement between the secondary surface (290) and elements of the device. As the pressure sensor (210) is moved to communicate with the secondary surface (290), the rangefinder (244) is used to determine the adjustments to the field of view of the projected image required so that the projected image is stabilized, e.g. static, such as maintaining a perceived size, even as the body (205) and associated projecting elements are subject to movement. The operation of the rangefinder (244) is explained in detail in FIG. 3 below. Accordingly, the rangefinder is provided to stabilize the projected image as the device is moved in relation to the secondary surface.

The body (205) is further configured with a microphone (250) and a speaker (252) operatively coupled to the processor (230) and memory (232). The microphone (250) is configured to receive voice data, and the speaker (252) is configured to project voice data. In one embodiment, an associated assessment may be configured with voice commands that require data input. Accordingly, the microphone (250) and speaker (252) are operatively coupled to the processor (230) to enable voice and oral data and to support interaction with the interactive commands. The microphone (250) and speaker (252) may also be used in a “mobile phone” mode when there is a wireless connection at (262) to enable voice communication through the body (205). In one embodiment, the wireless connection may be but is not limited to radio, free-space optical, sonic and electromagnetic induction modes. In one embodiment, the wireless connection is but is not limited to RF, WiFi, Bluetooth and other wireless networks. Thus, the speaker and microphone are configured to facilitate audible interaction with a projected image.

The device shown and described in FIGS. 1 and 2 is configured to project an image onto a secondary surface, and more specifically to receive data corresponding to user interaction with the projected image. Referring to FIG. 3, a flow chart (300) is provided illustrating a process for projection of an image from the device onto a secondary surface and resolving and/or correcting distortion of the projected image view. The basic components of the calculation pertain to geometry of the rendering of the image and the location of the rendered image with respect to the secondary surface. As shown, the device is activated to project an image onto a secondary surface (302). In one embodiment, the device is configured with a toggle switch that can be actuated to enter an active projection mode, although the use of the toggle switch should not be considered limiting. For example, in one embodiment, one or more of the momentary switch(es) may be employed to enter the active projection mode. Once in the active projection mode, a main feedback loop pertaining to the projection is entered. In one embodiment, the main feedback loop is active and remains active during this mode, and imports data from one or more sub-loops that are active as background processes or sub-loops. Therefore, entering active projection begins resolution and/or correction of a projected image on a secondary surface based on a feedback loop.

As shown, the main feedback loop retrieves data from the IMU(s) (304), including the orientation of the device with respect to the secondary surface that will be receiving the image projection. In addition, depth data is obtained from the rangefinder (306), including the distance between the device and the secondary surface that will be receiving the image projection. The device may be configured to display different images for different purposes, including but not limited to, cognitive assessments. As such, different images may have different geometries which may require a different adjustment algorithm. Accordingly, the image projection may need to be adjusted based on orientation and depth data received and the type of image displayed.

In addition to the data retrieved at steps (304) and (306), two dimensional position data in the form of optical flow is retrieved (308). In one embodiment, the optical flow data reports changes in pixel location, with these changes corresponding to changes in at least one of the two dimensions observed by the optical flow sensor. The optical flow sensors identify patterns between images to determine how the pattern has changed between images. The detected change corresponds to movement or re-orientation of the device as the patterns detected by the optical flow sensor are static patterns on the secondary surface. In one embodiment, the optical flow data is retrieved from one or more optical flow sensors (150). Thus, data is acquired from the optical flow sensors is communicated to the main feedback loop, along with the rangefinder and IMU data, in order to determine the three-dimensional position and orientation of the device.

In one embodiment, two or more optical flow sensors enable optical stereo triangulation to determine range thus providing the functionality of the rangefinder. When using the two or more optical flow sensors for stereo triangulation, the same patterns used to determine two dimensional movement are used to determine depth by finding corresponding points in the two image scenes from the separate optical flow sensors and determining the angle from each sensor to corresponding points. Accordingly, two optical flow sensors can provide three-dimensional position data.

After the data is obtained at steps (304)-(308), the position and orientation of the device is predicted for the time of the actual projection of the image (310), and the image location in the projection area is calculated (312). The orientation prediction is employed to calculate image geometry (314), including image size, based on predicted orientation and position, and in one embodiment corrections. The position of the device, and more specifically, the projection of the image, may yield a trapezoid or similar geometric shape with respect to the image projection frame of reference. However, it may be desirable that the image projection is in a rectangular shape or similar shape with respect to the secondary surface, also known as image perspective transformation. As such, the image calculation at step (314) effectively converts the image to project in its entirety on the secondary surface in a rectangular shape or similar geometric shape. Proceeding step (314), the image is projected from the device, based on the calculated image location, and received on a secondary surface (316). Accordingly, an adjusted image is projected on the secondary surface.

It is understood that the secondary surface may be imprecise, e.g. an uneven surface. Similarly, it is understood that the device may not be supported on a stable surface, and is therefore subject to fluctuations in movement. Either of these aspects may cause distortion of the projected image, or a distortion of the image view. To mitigate these distortions, the camera (242) is employed to observe the projected image (318). Using machine vision, the camera determines the location of the corners of the projected image based on a corner detection algorithm (as known in the art) (320), measures the pixel distance between the corners (322), determines spatial distance between the corners (324), determines the difference between the measured spatial distance and the desired corner locations (326), and determines the difference between the measured pixel distance to desired corner locations (328). Based on the measurements and determinations at steps (322)-(328), it is determined if the calculated image geometry at step (314) needs modified to correct distortions (330). It is understood that the distortions can occur from a variety of sources, including, but not limited to dirt on the lens of the camera, uneven secondary surface, and/or inaccurate or error associated with a value of the IMU(s). If at step (330) it is determined that there is a distortion, the process returns to step (302) to obtain current data value, and then calculates the image geometry at step (314). However, if at step (330) it is determined that there are no distortions, the image remains projected onto the secondary surface until such time as the image frame changes. Accordingly, the process shown herein addresses both proper or complete image projection and mitigation of distortions associated with the projected image.

The body that embeds the elements including the sensors and projectors is in a portable projection device. In one embodiment, the device is in the form of a stylus, or similarly configured body. Regardless of the shape and size, the body is subject to movement and distortion associated with the image projected from the body; this distortion is mitigated if not eliminated via the process shown and described in FIG. 3. The process shown and described in FIG. 3 is periodically updated. In one embodiment the update takes place at a frequency ranging from 30 to 60 Hertz or higher. Accordingly, the update procedure provides periodic adjustments to projected images based on the movement and orientation of the body.

As shown and described in FIGS. 1 and 2, the elements embedded in the body are configured to project one or more images onto a secondary surface. The device is also configured to interact with the projected image(s). Referring to FIG. 4, a flow chart (400) is provided illustrating a process for interacting with the projected images. For descriptive purposes, the interaction is described with respect to an interactive program in the form of a cognitive assessment, wherein interaction with one or more of the projected images is required. For example, one form of the cognitive assessment is a simple reaction time test that requires selection within the perimeter of the projected image together with measuring an associated time interval from image projection to image selection, in one embodiment, the area of the image that is selected is also identified and measured. Accordingly, an assessment may be performed based on the interaction with between the operation of the device and an image projected by the device.

As shown, an image projection counting variable, X, is initialized (402), and an associated non-selected image counting variable, Y, is initialized (404). With respect to use of the device for assessment, and in one embodiment cognitive assessment, the non-selected image counting variable tracks lapses in the assessment, such as, but not limited to, incorrect assessment results. Following the initializations, an associated image, imageₓ, is projected from the body onto a secondary surface (406). The projection includes reduction of distortion of the image as shown and described in FIG. 3. Therefore, the assessment is initialized and an image is projected on a secondary surface configured for user interaction.

Following the projection at step (406), a timer is started (408). A timer is employed to track the time interval between image projection and image selection, or in one embodiment, image interaction. In one embodiment, the measured time interval is a factor subject to evaluation of associated test results. Additionally, in order to facilitate selection, one or more IMU(s) are embedded in the device, see FIGS. 1 and 2. The IMU(s) include an accelerometer, gyroscope, and compass, embodied therein. The device also includes a pressure sensor that functions in conjunction with the IMU(s), such as when the device is in communication with the secondary surface. As shown in FIGS. 1 and 2, the pressure sensor is embedded in the body of the device, and in one embodiment, is attached to or in communication with the device body and is configured to interact with the projected image. In one embodiment, a laser pointer and a momentary switch are embedded in the body of the device, and configured to interact with the projected image. Accordingly, a plurality of different sensors can facilitate interaction with the projected image.

Following step (408), the projected image is either selected (410) within a pre-programmed time interval, followed by measurement of the time from projection onto the secondary surface to the selection together with an increment of the image selection counting variable, X, (412), or the time interval available for image selection expires (414). The selection at step (410) is associated with the pressure sensor, momentary switch, or alternate selection device. In one embodiment, the selection by the pressure sensor requires a threshold amount of force to be detected, with the selection within the time interval and within the perimeter of the projected image. If any of the elements associated with selection at step (414) have not been reached, the associated counting variable Y is incremented (416), so that the quantity of non-selected images may be a part of the assessment. In one embodiment, the assessment may be configured to gather data pertaining to the area of the image that was selected. Accordingly, the elements associated with the selection must be reached within a pre-programmed time interval in order for the time interval to be measured.

Image selection or interaction requires tracking of movement of the device so that any image selection or other interaction with the projected image is ascertained. In one embodiment, the term image refers to that which is displayed on a secondary surface, and the term image cue or visual stimulus, herein referred to as visual stimulus, refers to that which is selected from the secondary surface. In one embodiment, the assessment includes a sequential projection of images onto the secondary surface, and multiple measurements gathered from selection of one or more visual stimulus with an associated time measurement for each selection, or non-selection. Both aspects, selection and non-selection, are forms of measurements.

Following either of steps (412) or (416), it is determined if the assessment program is completed (418). A negative response to the determination at step (418) is followed by projection of the next image in the assessment (420) and a return to step (406). However, a positive response to the determination at step (418) is an indication that the assessment is complete. The value of the non-selected image(s) counting variable Y is assigned to the variable Y_{Total} (422), the value of the selected image(s) counting variable X is assigned to the variable X_{Total} (424), and the assessment concludes. Accordingly, the assessment includes image selection which takes place through a pressure sensor, momentary switch, or alternate selection device.

Details of an image selection embodiment will be described below with a detailed description of the device and the embedded components. In one embodiment, the image selection device may be in the form of a pointer, or an equivalent selection mechanism associated with the device. At such time as the assessment image is projected onto the secondary surface, selection of the image cue may take place visually via a pointer e.g. cursor rendered on the secondary surface in the location that the device is oriented or moved towards. The pointer e.g. cursor can be moved to a changed position by moving or re-orienting the device and a selection can be made by using the pressure sensor and/or momentary switch(es) embedded on the device or an alternate selection device.

Referring to FIG. 5A, a block diagram (500A) is provided illustrating an example of a device projecting an image and interaction with the projected image in an initial state. As shown, the device (550) projects the image (510) within the available projection area (507) onto a secondary surface (505). The device (550) is shown positioned in the vicinity of the projected image (510), although not physically contacting the secondary surface (505) or the projected image (510). As shown, the projected image (510) is separated into a plurality of regions (520), (530), and (540). Although only three regions are shown and described, the quantity of regions should not be considered limiting. Similarly, for descriptive purposes, the projected image (510) and associated regions will be described herein with respect to an assessment tool, although this is an exemplary use, it should not be considered limiting. As shown, region (520), also referred to as region₁, is configured to exhibit the primary aspects of the assessment in the projected image. Additionally, region (530), also referred to as region₂, and region (540), also referred to as region₃, are referred to herein as secondary regions. In this example, region₂ (530) displays a back button, and region₃ (540) displays a forward button. The selection of the back and forward buttons enables a user or participant of the assessment to return to a prior assessment frame or to proceed to the next frame of the assessment. Accordingly, the user may use the device to interact with the different regions in the projected image.

The device (550) is shown with two momentary switches (562) and (564). In this example, an image of an assessment frame is shown in region₁ (520), and the device (550) is operating in a mode that enables use thereof as an image interaction device. As the assessment takes place, an initial image location is determined, and the direct operating mode is engaged. The device (550) projects a cursor within the available projection area (507). The position of the device (550) may be moved so that cursor may be directed to a specific region of the image or a region outside of the image. As shown herein, the cursor is shown in an initial position (570) in region₁ (520). Accordingly, the image location has been determined, the image has been projected and the projected image is available for interaction.

Referring to FIG. 5B, a block diagram (500b) is provided illustrating an example of a device projecting an image and the interaction with the projected image in a second state. The projected image is interacted with as the device is moved or oriented in such a fashion that the cursor moves to a subsequent position (580) in region₂ (530). The projected image (510) stays in a similar position with respect to the secondary surface (505). The available projection area (507) changes with respect to the secondary surface (505) and the projected image (510). Accordingly, the projection area changes location depending on the orientation and movement of the device.

Interaction with the projected image continues based on the cursor position. As described above, region₂ (530) includes a ‘back’ button. With the cursor present at position (580) and projected onto the back button in region₂ (530), one of the momentary switches (562) or (564) may be engaged, with the engagement activating the function of the selected region, e.g. the back button. In other words, engagement of one of the momentary switches (562) and (564) at such time as the cursor is in the subsequent position (580), will cause the assessment image to revert to the prior assessment image, and the image projected onto region₁ (520) will be the image of the prior assessment image. Accordingly, as shown in this example, the use and engagement of the momentary switches supports and enables interaction with the projected image without physically engaging the pressure sensor of the device.

During interaction with the projected image, there are a plurality of different interactions that can occur between the available projection area, secondary surface and projected image. In one embodiment, the elements of the device body maintain the projected image in a similar location with respect to the secondary surface. When the device body is moved or re-oriented, the available projection area is moved or re-oriented while the projected image is maintained in the similar location. As the device body is moved or re-oriented, the projected image may approach a boundary of the projection area. The interaction between the image and the boundary of the available projection area may be displayed in a variety of manners. In one embodiment, selectable behavior modes that may occur for displaying the projected image may be but are not limited to, a drag mode and a crop mode. In one embodiment, the mode selection may occur by a momentary switch or interaction with a graphical user interface. The behavior modes relate to how the image is displayed when the body is being moved or oriented in such a manner that the projection area boundary is moved to an edge of the projected image. In the drag behavior mode, when the projected image interacts with the boundary of the projected area, the image location is not maintained and is dragged to a new location on the secondary surface. The projected image is maintained in the new location until another boundary interaction. Accordingly, in drag mode, the edges of the projected image are maintained within the available projection area and moved to stay within the projected area.

In crop behavior mode, when the projection area boundary is moved and reaches the projected image, the image location is maintained and not moved with the projection area. As the projection area moves, the projected image is cropped version of the original image in order to maintain the original image location. In one embodiment, only the portions of the image within the projection area are displayed. In one embodiment, the projection area may be moved to a distance where no portions of the image are displayed. In one embodiment, the projected image blinks at a low frequency to indicate that the image is cropped due to the image location being partially outside the projection area boundary. In one embodiment, the frequency at which the projected image blinks is 1 Hz. Accordingly, interaction with a projected image may occur in a plurality of manners.

The apparatus and method of operation shown and described herein may be utilized for cognitive and/or psychological assessment(s). More specifically, the apparatus and associated method shown and described in FIGS. 1-5 supports portability. By embedding or otherwise configuring the apparatus with a cognitive and/or psychological assessment, portability of such an assessment becomes feasible. More specifically, the apparatus translates into a portable assessment device for use at any secondary location. Any selected or utilized assessment may be projected onto a secondary surface through the apparatus, and interaction with the secondary surface is also supported and enabled through the apparatus.

Assessment is based on a combination of tests that assess various cognitive and/or behavioral impairments, such as but not limited to cognitive functioning, sleep, mood, posttraumatic stress, daily functioning, as well as level of motivational effort. The behavioral tests include a battery of one or more tests provided to a subject to assess if there is a psychological impairment and the cause thereof. Similarly, the neuro-cognitive tests include a battery of tests provided to a subject to assess a cause of cognitive impairment. The order of the tests should not be considered limiting. In one embodiment, cognitive assessment may precede the psychological assessment. From a library of potential tests on the device, several test batteries can be configured. One test battery can include several neuro-cognitive tests to be used for a brief screening following an injury or condition, such as a concussion. Another test battery can include both several neuro-cognitive tests and psychological screening devices be used as a brief screening to help identify suspected impairment, including but not limited to concussion, depression or post-traumatic stress disorder, and exhaustion. Still another battery comprised of up to a dozen neuro-cognitive and behavioral tests to assist healthcare professionals to determine the specific cause and level of a person's impairment.

Many such batteries from the library of tests can be configured in order to accommodate the needs of the healthcare professional. A clinician or trained personnel may employ a configured module to provide screening of the subject in the environment in which they operate or received an injury, or else in a specialized medical clinic. The output from the assessments and their associated batteries of tests can provide an output with an indicator to assist the healthcare professional in their initial assessment of the subject's level of functioning in a variety of neuro-cognitive and/or psychological domains. For example, in one configuration, the output may include indicia in the form of a color coded chart, with green indicating the subject is in a normal range, yellow indicating there is a possibility of an impairment that may need further analysis, and red suggesting the possibility of impairment that may require a further assessment and possibly treatment of the tested person.

Examples of cognitive assessments include, but are not limited to, simple reaction time, procedural reaction time, spatial processing, code substitution learning, code substitution recall, Go-NoGo, memory search, and match to sample. Similarly, examples of psychological assessments include, but are not limited to, deployment stress inventory (DSI), psychological health questionnaire (PHQ-9), primary care PTSD (PC PTSD), Pittsburgh sleep quality inventory (PSQI), post-traumatic stress disorder check list, and insomnia severity index.

As shown above, there are various cognitive and psychological tests. Different combinations of tests may be administered depending upon the scenarios. The following description(s) pertain to examples of such scenarios. A first line of care includes a first battery of tests, also referred to herein as rapid tests. The following tests are administered in the first battery: Simple Reaction Time, and Choice Reaction Time Tests. The tests in this first battery are cognitive efficiency reaction time tests. The first line of care is intended to be administered in the field proximal to the time of injury (typically within 24 hours of suspected concussion), and includes both of the described tests. Results of the test are indicative of the immediate care required, e.g. supports the healthcare provided in assessing if a further assessment or treatment may be required.

A second line of care includes a second battery of tests in the form of a combination of cognitive and psychological tests, also referred to herein as brief tests. The following tests are administered in the second battery: Simple Reaction Time, Procedural Reaction Time, Spatial Processing, Code Substitution, Go-NoGo, PHQ-9, PC-PTSD, and ISI. The second line of care can be administered at least 24 hours following after a suspected concussion, or at any time due to any suspected impairment of functioning, such as disturbed mood, exhaustion, pain, etc. The first and second line batteries described above are intended for screening purposes in order to suggest the need for further evaluation by a specialized healthcare professional. These first two test batteries can be utilized by provider-extenders (medics, corpsman, psych techs, medical assistants, nurses, etc.) under the guidance of a licensed healthcare professional.

A third line of care includes a third battery of tests, including a more in depth combination of cognitive and behavioral tests, also referred to herein as standard tests. The following tests are administered in the third battery: Simple Reaction Time, Procedural Reaction Time, Spatial Processing, Code Substitution, Go-NoGo, Memory Search, Match to Sample, PHQ-9, DSI, PSQI, and PCL-M. The third battery of tests is intended to be administered at least forty-eight hours or more after a suspected concussion or at any time due to suspected impairment from any cause (lingering effects from an earlier concussion, mood disturbance such as posttraumatic distress or depression, or exhaustion due to cumulative stress or insomnia). This battery includes each of the described tests. Whereas the first two batteries can be delivered in any environment, such as where the injury occurred by a provider-extender, this third battery is intended to be delivered in a traditional healthcare setting by a more senior healthcare professional, typically a licensed healthcare provider. It is intended to assist the healthcare professional to more specifically determine the extent of impairment and the specific causes of the impairment so that a diagnosis and recommendation for treatment can be more accurately made by that healthcare professional. Other configurations are available as well, including a Clinic Version that includes several functional tests, and can select Neuro-Cognitive tests only, Psychological tests only or each test separately, as needed by the healthcare provider. For example, in one embodiment, the participant cannot select among the tests to be administered in each test battery, and must attend to each of the tests therein.

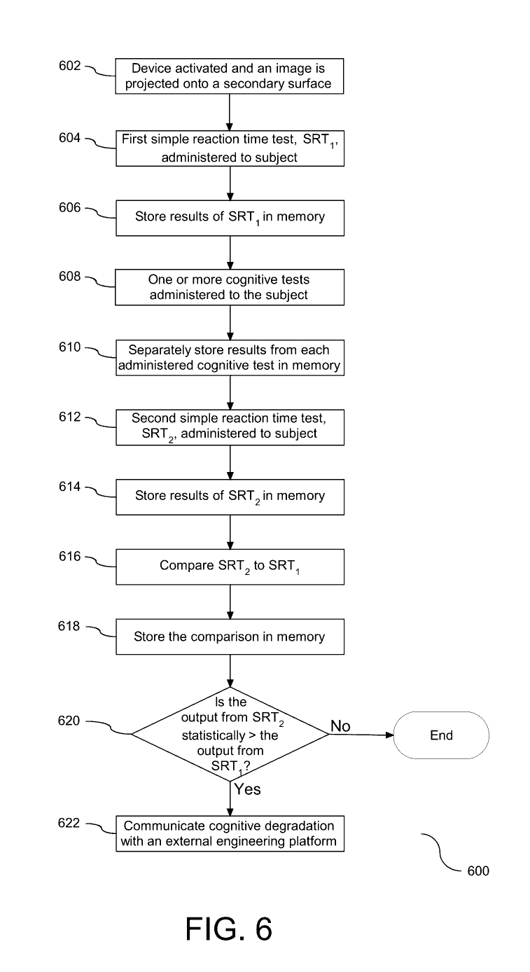

As shown and described herein, the cognitive and/or psychological assessment may be embedded in the hardware of the device, or it may be uploaded to the device via a wired or wireless connection. Referring to FIG. 6, a flow chart (600) is depicted to illustrate one aspect of assessing cognitive efficiency using the device and its functionality described herein. As shown, the device is activated and an image is projected onto a secondary surface (602). The projected image may be a menu of options available, such as a menu of assessments that are embedded or otherwise in communication with the device. Details of image projection and selection are shown and described in FIGS. 1-5.

In the example shown herein, the device is used to administer a cognitive assessment. A first simple reaction time test, SRT₁, is administered by projection of the test onto a secondary surface (604). As the test is administered, the results of the test are stored in memory (606). In one embodiment, the memory may be local to the device. Similarly, in one embodiment the memory may be remote from the device, with the device employing a communication protocol to send the data to a remote storage location. Similarly, in one embodiment, the data is communication to a data center that is a shared resource at a remote location, i.e. a cloud storage resource. Following the conclusion of SRT₁, one or more cognitive tests are administered to the subject (608). Results from each administered cognitive test are separately stored in memory (610). In one embodiment, the one or more cognitive tests are administered immediately after administration of SRT₁. Similarly, in one embodiment, the administration of cognitive tests is limited to a single test, or in one embodiment may include between two and five cognitive tests.

Following the conclusion of the final cognitive test, a second simple reaction time test, SRT₂, is administered to the subject (612), and the results of the SRT₂ are stored in memory (614). Thereafter, a comparison of the first and second simple reaction time tests is conducted (616), e.g. (SRT₁-SRT₂) or (SRT₂-SRT₁). The comparison of the tests is shown as being stored in memory (618). In one embodiment, the results may be evaluated prior to storage, or may be communicated to a secondary location for evaluation and/or storage.

As shown, comparison of the first and second simple reaction time tests (SRT₁ and SRT₂) based on the sequential order in which the tests are administered produces a unique data signature when compiling the result data. In one embodiment, the data received from the comparison of the first and second simple reaction time tests (SRT₁ and SRT₂) yields a significant brain vital sign of cognitive efficiency. The sequential administration of the tests as shown and described in FIG. 6 together with the tests used produces the unique data signature. In one embodiment, the signature is directly related to the integrity, order, and quantity of tests administered in the sequence shown and described in FIG. 6. Similarly, in one embodiment, the comparison may include reaction time test data with other patient test to determine cognitive health or cognitive efficiency.

Comparison of the first and second simple reaction time test data is a comparison of data for a specific subject, e.g. patient. In the example shown in FIG. 6, the patient's second simple reaction time test (SRT₂) data is compared to their test data for the first simple reaction time test (SRT₁). This measurement and subsequent comparison is employed to determine if there is a statistical difference in the test results, and if the comparison data shows a statistical value of a worsening cognitive condition, then it warrants a concern of an atypical data output. In one embodiment, it is determined if the comparison of the first and second reaction time test (SRT₁ and SRT₂) data shows a decrease, also referred to as a degrading cognitive condition (620). A positive response to the determination at step (620) is followed by communicating the cognitive degradation with an external engineering platform (622) or in one embodiment, communicating the cognitive degradation to a healthcare professional. In one embodiment, the external engineering platform may include a software or hardware patient platform. A negative response to the determination at step (620) concludes the evaluation of the administered simple reaction time tests.

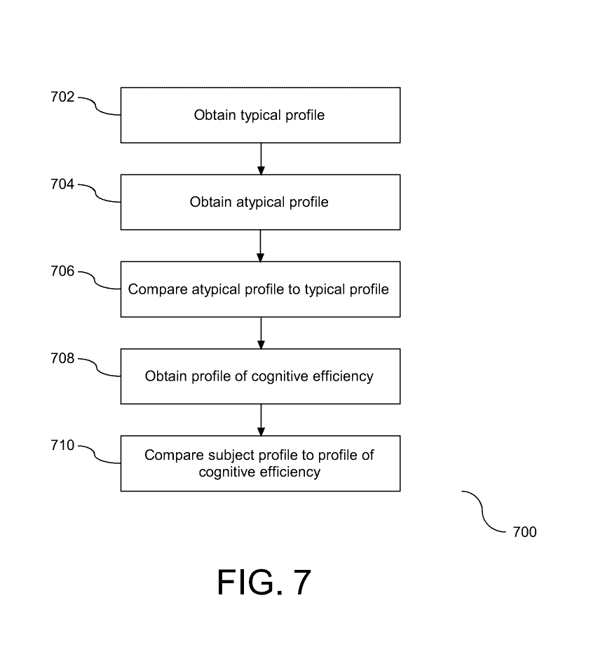

Referring to FIG. 7 flow chart (700) is provided illustrating comparison of the simple reaction times based on the sequential administration of tests shown in FIG. 6. Use of the sequential order and processing of the tests yields results that are referred to herein as a unique signature. Prior or subsequent to the administration of the sequential ordering of the tests, a normal or typical profile is obtained (702). In one embodiment, the sequential ordering of the tests is conducted on a single subject that is typical and the comparison of the simple reaction time tests for this subject are identified and stored as a normal or typical profile or a normal or typical unique signature. Similarly, in one embodiment, the sequential ordering of the tests is conducted on two or more subjects that are normal or typical and the comparison of the simple reaction time tests for each subject is identified and stored as a normal or typical profile or a normal or typical unique signature. In one embodiment, statistical analysis is performed on the plurality of tests to create a mean and/or average signature for the normal or typical subject. Following step (702), an atypical profile is obtained (704). The process of obtaining the atypical profile is similar to the normal or typical profile except that the subject(s) for whom the data is gathered is in an atypical state. In one embodiment, there may be different levels of atypical states, and as such, more than one unique signature for an atypical state may be gathered and identified. Accordingly, at leave two unique signatures are obtained, including an atypical signature and a typical signature.

As shown in FIG. 6, a comparison of the first and second simple reaction time tests is conducted to obtain a vital sign of cognitive efficiency. Similarly, the atypical profile may be compared to the non-atypical profile (706) to obtain a profile of cognitive efficiency (708). In one embodiment, a range of values may be obtained from the profile data, including a range of values for cognitive efficiency, with the range indicating profiles that have a greater cognitive efficiency and a diminished cognitive efficiency. The cognitive efficiency from the tests being administered to the subject is compared to the profile of cognitive efficiency (710). Results from the comparison of the subject to the profile are indicative of placement of the subject's cognitive efficiency with the range of profile cognitive efficiencies. In one embodiment, the cognitive efficiency results indicate whether the subject is in an atypical state. Accordingly, in addition to or separate from the signature, the profile comparison for cognitive efficiency is a device employed to assess a typical or atypical state of the subject.

The unique signature obtained from the sequential test administration shown and described in FIG. 7 is due to the nature of the tests used, including the integrity, order, and quantity of the tests. In one embodiment, the comparison of test data is based on comparison of the signature with a typical profile and comparison of the signature with an atypical profile. Similarly, in one embodiment, the unique signature functions similar to a thermometer, however in place of temperature measurement, the unique signature measures a state of the subject. Comparison of the measured state to a stored profile or set of profiles provides a measurement of a level of an atypical state, similar to the temperature measurement on a thermometer to a normal body temperature and a raised body temperature. Accordingly, the unique signature is obtained from the sequential delivery of the simple reaction time test with one or more cognitive tests there between, and functions as a unique device for assessing an atypical state of the subject.

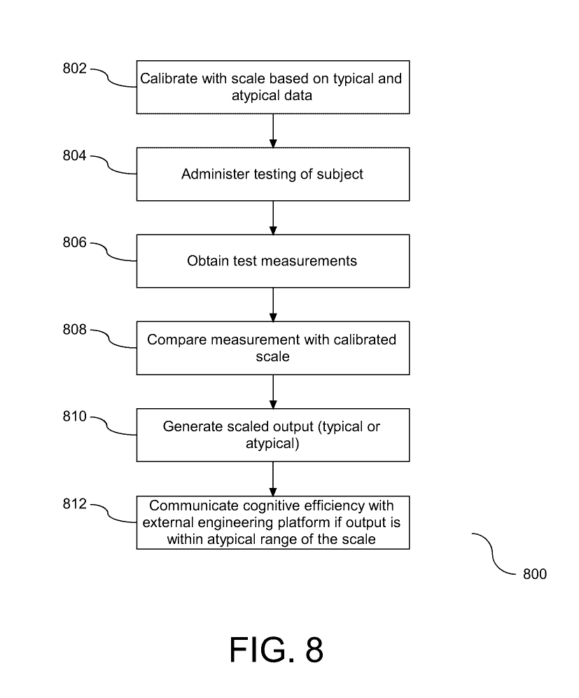

Referring to FIG. 8, a flow chart (800) is provided illustrating a method for employing a cognitive metering device with assessment data. The metering device functions similar to functionality of a thermometer with respect to a measurement scale, but is employed for cognitive data assessment. As shown, before the device can be used for evaluating assessment data, a scale is established for the device (802). In one embodiment, the scale and calibration is based upon a set of typical and atypical data, including an associated data range. Once the scale and calibration is established, testing may be administered (804), and output from the tests in the form of measurement data is obtained (806). The measurements may be any cognitive data. In one embodiment, the measurement(s) may be a single measurement that is compared to the norm. More specifically, the measurement(s) from the assessment(s) is compared with the calibrated scale of the metering device (808), and a scaled output is generated (810). The scaled output indicates with the measurement(s) show that the data is in the typical range or the atypical range of the calibrated scale. For data that falls in the atypical range, this is indicative of a possible cognitive impairment. In one embodiment, the metering device communicates the cognitive impairment with an external platform (812), such as a patient platform. Accordingly, the metering device is calibrated with data that represents typical and atypical measurements, so that assessment data can be measured with the metering device to determine cognitive impairment.

The method for employing a cognitive metering device shown and described in FIG. 8 is calibrated and scaled with a set of data. It is understood that cognitive assessment data may be subject to change, and furthermore, in different environments data may have different interpretation. Furthermore, the scale in the metering device may be different based upon a different data set having a different data range. Accordingly, there are various factors that may require a re-calibration or re-scaling of the device.

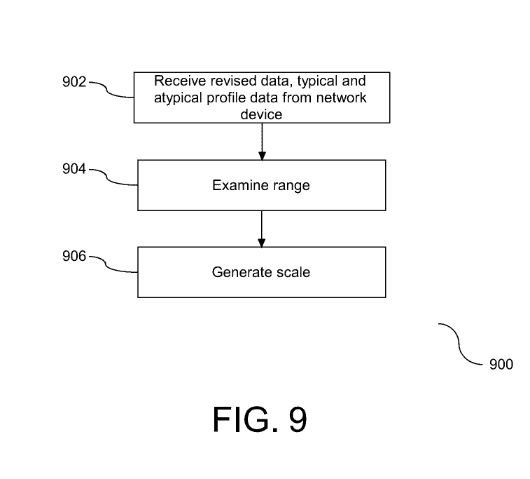

Referring to FIG. 9, a flow chart (900) is provided illustrating a process for calibrating or re-calibrating the metering device. The metering device receives a revised cognitive data set (902), with the revised data including values representing a typical profile and an atypical profile. In one embodiment, the metering device receives the revised data set from a network device. The range associated with the revised data set is examined, together with the profile representing a typical profile and an atypical profile (904). Thereafter, a scale for the received data is generated (906). Accordingly, the metering device may be re-calibrated in response to receipt of revised cognitive data.

The cognitive assessment device described herein may be configured with test batteries that are preconfigured for specific assessments. In one embodiment, the assessment device may operate in a dynamic manner. More specifically, the assessment device may be configured with hardware for administering the assessment(s).

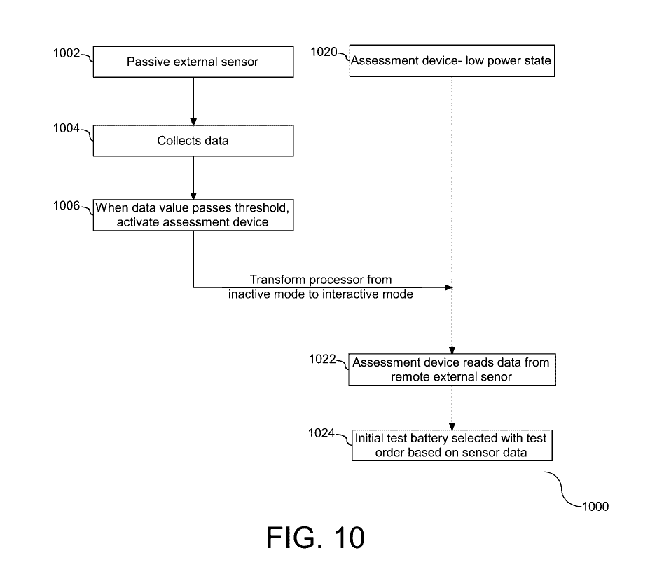

Referring to FIG. 10, a flow chart (1000) is provided illustrating a process for supporting interaction with the portable projection device, with the interaction affecting the state of operation of the device. As shown, a passive external device is provided physically detached from a portable assessment device (1002). The passive device functions to collect data (1004), and in one embodiment sends the collected data to the portable assessment device (1006), shown and described in FIGS. 1-6. In one embodiment, the passive device communicates with the portable assessment device through an open application program interface. While the passive device is collecting data, the portable assessment device operates in a low power state (1020), examples including but not limited to sleep mode, standby mode, hibernate mode, or in one embodiment an alternate low power mode. The sleep mode and standby mode are low power states where the visual display and any persistent storage devices are turned off, but the memory chip, such as RAM, is continuously refreshed. In addition, the processing unit is throttled down to a low power state. In one embodiment, an alternate power saving mode, such as a hibernate mode, may be utilized by the assessment device.

When the data collected by the passive external sensor attains a value that exceeds a threshold, the portable assessment device is activated (1006). More specifically, the operating state of the portable assessment device is transformed from the low power state to an active mode. In one embodiment, the passive external sensor, and more specifically, the data from this sensor, controls activation of the assessment device. In one embodiment, the passive external sensor communicates with the assessment device through a wireless communication protocol, such as Bluetooth. The passive external sensor may include, but is not limited to, a helmet sensor, a sensor attached to a bracelet, and other forms of passive sensors. Following the activation, the assessment device, reads the data received from the remote external sensor (1022). An initial test battery is selected based on the received sensor data (1024). In one embodiment, the sensor data controls the test selection. In another embodiment, a profile of a signal received by the assessment device from the passive sensor will dictate the test selection. As described above, test data is received and analyzed. In one embodiment, real-time results of the data received from the test battery can be determinative of selection of one or more additional assessments. The combination of the passive sensor in communication with the assessment device enables the assessment device to operate in a low power state until such time as the data collected form the sensor warrants an assessment. Accordingly, the passive sensor functions as an external hardware device that transforms the operating state of the assessment device, and more specifically, transforms the state from a low power state to an interactive mode for assessment.

As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. The portable assessment device, as shown and described in FIGS. 1-6 may be utilized to leverage the functionality of the cloud model to support the assessments and associated functionality, data storage, etc. Specifically, the portable device is shown with a communication platform (110) that supports communication between the portable device and externally available shared resources, e.g. cloud supported products and services, also referred to herein as a cloud model. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and devices supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

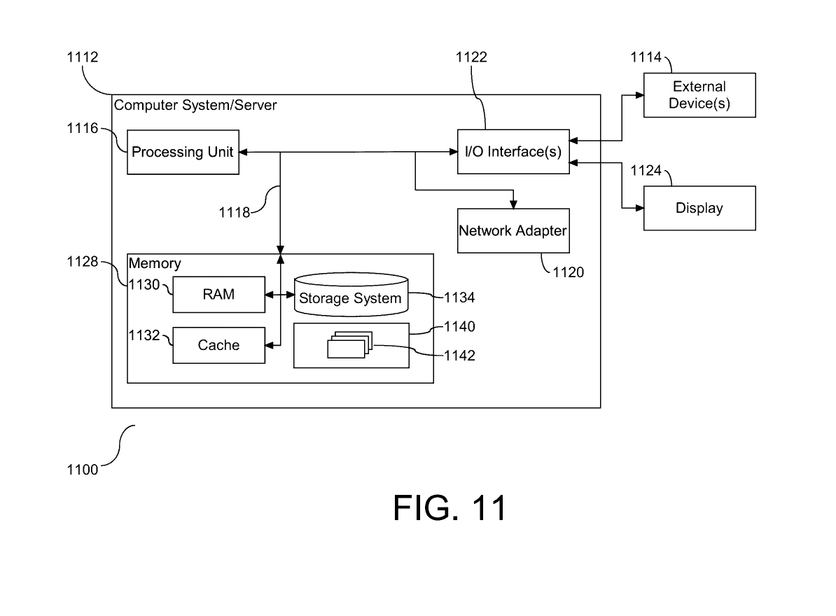

In one embodiment, a tool is configured to perform the functions of correcting geometry and distortions of the projected image and interacting with the projected image as displayed on the secondary surface. Aspects of a tools, and the tool's associated functionality may be embodied in a computer system/server in a single location, or in one embodiment, may be configured in a cloud based system sharing computing resources. Referring now to FIG. 11, a schematic of a system (1100) is provided. In one embodiment, system (1100) is a cloud computing node. The cloud computing node is only one example of a suitable cloud computing node and is not intended to suggest any limitation as to the scope of use or functionality of the embodiments described herein. Regardless, the cloud computing node is capable of being implemented and/or performing any of the functionality set forth hereinabove.

In the cloud computing node is a computer system/server (1112), which is operational with numerous other general purpose or special purpose computing system environments or configurations. Examples of well-known computing systems, environments, and/or configurations that may be suitable for use with computer system/server (1112) include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (1112) may be described in the general context of computer system executable instructions, such as program modules, being executed by a computer system. Generally, program modules may include routines, programs, objects, components, logic, data structures, and so on that perform particular tasks or implement particular abstract data types. Computer system/server (1112) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server (1112) is shown in the form of a general-purpose computing device. The components of computer system/server (1112) may include, but are not limited to, one or more processors or processing units (1116), a system memory (1128), and a bus (1118) that couples various system components, including system memory (1128) to processor (1116).

Bus (1118) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server (1112) typically includes a variety of computer system readable media. Such media may be any available media that is accessible by computer system/server (1112), and it includes both volatile and non-volatile media, removable and non-removable media.

System memory (1128) can include computer system readable media in the form of volatile memory, such as random access memory (RAM) (1130) and/or cache memory (1132). Computer system/server (1112) may further include other removable/non-removable, volatile/non-volatile computer system storage media. By way of example only, storage system (1134) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (1118) by one or more data media interfaces. As will be further depicted and described below, memory (1128) may include at least one program product having a set (e.g., at least one) of program modules that are configured to carry out the functions of embodiments.

Program/utility (1140), having a set (at least one) of program modules (1142), may be stored in memory (1128) by way of example, and not limitation, as well as an operating system, one or more application programs, other program modules, and program data. Each of the operating system, one or more application programs, other program modules, and program data or some combination thereof, may include an implementation of a networking environment. Program modules (1142) generally carry out the functions and/or methodologies of the embodiments as described herein. In one embodiment, one program module (1142) performs the functions of the tool.

Computer system/server (1112) may also communicate with one or more external devices (1114) such as a keyboard, a pointing device, a display (1124), etc.; one or more devices that enable a user to interact with computer system/server (1112); and/or any devices (e.g., network card, modem, etc.) that enable computer system/server (1112) to communicate with one or more other computing devices. Such communication can occur via Input/Output (I/O) interfaces (1122). Still yet, computer system/server (1112) can communicate with one or more networks such as a local area network (LAN), a general wide area network (WAN), and/or a public network (e.g., the Internet) via network adapter (1120). As depicted, network adapter (1120) communicates with the other components of computer system/server (1112) via bus (1118). It should be understood that although not shown, other hardware and/or software components could be used in conjunction with computer system/server (1112). Examples, include, but are not limited to: microcode, device drivers, redundant processing units, external disk drive arrays, RAID systems, tape drives, and data archival storage systems, etc.

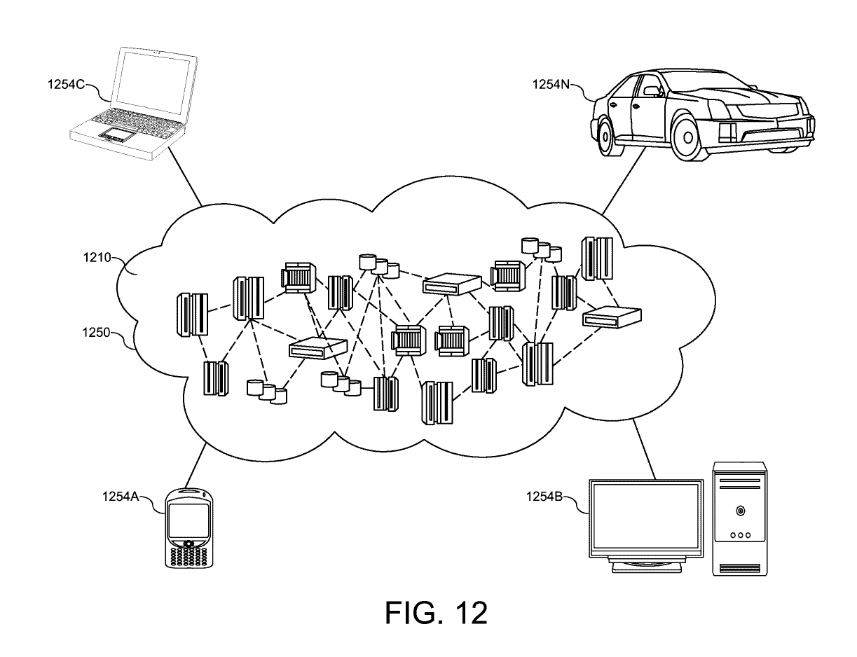

Referring now to FIG. 12, an illustrative cloud computing environment (1200) is depicted. As shown, cloud computing environment (1200) comprises one or more cloud computing nodes (1210) with which local computing devices used by cloud consumers, such as, for example, personal digital assistant (PDA) or cellular telephone (1254A), desktop computer (1254B), laptop computer (1254C), and/or automobile computer system (1254N) may communicate. Nodes (1210) may communicate with one another. They may be grouped (not shown) physically or virtually, in one or more networks, such as Private, Community, Public, or Hybrid clouds as described hereinabove, or a combination thereof. This allows cloud computing environment (1200) to offer infrastructure, platforms and/or software as services for which a cloud consumer does not need to maintain resources on a local computing device. It is understood that the types of computing devices (1254A)-(1254N) shown in FIG. 12 are intended to be illustrative only and that computing nodes (1210) and cloud computing environment (1200) can communicate with any type of computerized device over any type of network and/or network addressable connection (e.g., using a web browser).

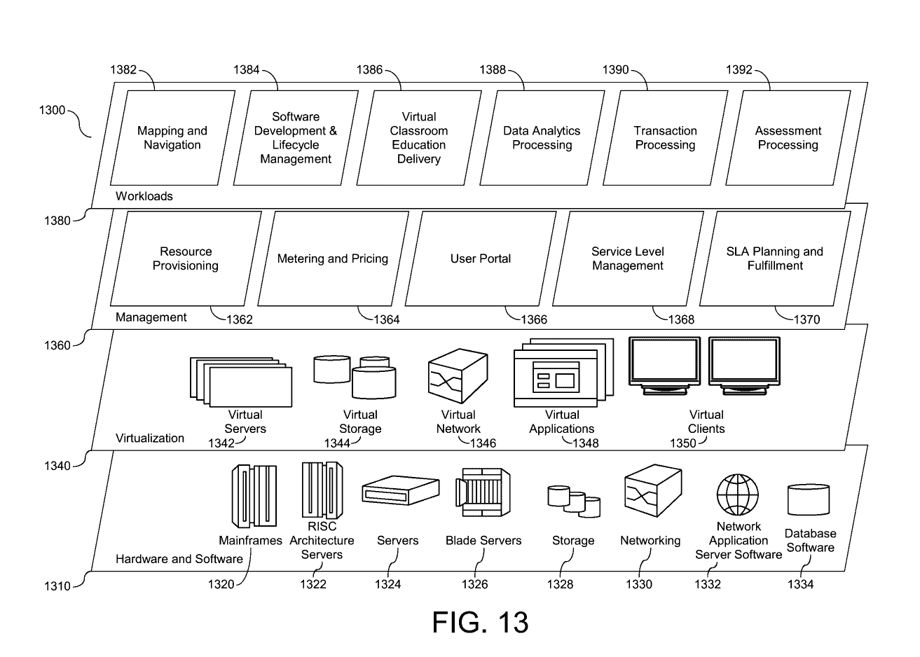

Referring now to FIG. 13, a set of functional abstraction layers (1300) provided by cloud computing environment (1200) of FIG. 12 is shown. It should be understood in advance that the components, layers, and functions shown in FIG. 13 are intended to be illustrative only and the embodiments are not limited thereto. As depicted, the following layers and corresponding functions are provided:

Hardware and software layer (1310) includes hardware and software components. Examples of hardware components include mainframes (1320); RISC (Reduced Instruction Set Computer) architecture based servers (1322); servers (1324); blade servers (1326); storage devices (1328); networks and networking components (1330). In some embodiments, software components include network application server software (1332) and database software (1334).

Virtualization layer (1340) provides an abstraction layer from which the following examples of virtual entities may be provided: virtual servers (1342); virtual storage (1344); virtual networks (1346), including virtual private networks; virtual applications and operating systems (1348); and virtual clients (1350).

In one example, management layer (1360) may provide the functions described below. Resource provisioning (1362) provides dynamic procurement of computing resources and other resources that are utilized to perform tasks within the cloud computing environment. Metering and Pricing (1364) provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal (1366) provides access to the cloud computing environment for consumers and system administrators. Service level management (1368) provides cloud computing resource allocation and management such that required service levels are met. Service Level Agreement (SLA) planning and fulfillment (1370) provides pre-arrangement for, and procurement of, cloud computing resources for which a future requirement is anticipated in accordance with an SLA.

Workloads layer (1380) provides examples of functionality for which the cloud computing environment may be utilized. Examples of workloads and functions which may be provided from this layer include: mapping and navigation (1382); software development and lifecycle management (1384); virtual classroom education delivery (1386); data analytics processing (1388); transaction processing (1390); and assessment processing of one or more aspects of the present embodiments (1392).

As will be appreciated by one skilled in the art, the embodiments described herein may be embodied as a method, a system, or a computer program product. Accordingly, aspects of the embodiments may take the form of an entirely hardware embodiment, an entirely software embodiment (including firmware, resident software, micro-code, etc.) or an embodiment containing software and hardware aspects. Furthermore, aspects of the embodiments may take the form of a computer program product embodied in one or more computer readable medium(s) having computer readable program code embodied thereon.

The computer program product may include a computer readable storage medium (or media) having computer readable program instructions thereon for causing a processor to carry out aspects of the present embodiments. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

Aspects of the embodiments are described herein with reference to flowchart illustrations and/or block diagrams of methods, systems, and computer program products according to embodiments of the embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The device described above in FIG. 1 has been labeled with devices in the form of sensors and a microprocessor, or in one embodiment a microcontroller. The devices may be implemented in programmable hardware devices such as field programmable gate arrays, programmable array logic, programmable logic devices, or the like. The devices may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the devices need not be physically located together, but may comprise disparate instructions stored in different locations which, when joined logically together, comprise the devices and achieve the stated purpose of the device.

Indeed, executable code could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

The present embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

Aspects of the embodiments are described herein with reference to flowchart illustrations and/or block diagrams of methods, apparatus (systems), and computer program products according to the embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed.

Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated. Accordingly, the implementation of the portable interactive image assessment ensures cognitive or alternative assessments to be conducted in a transient manner, and in any environment with a secondary surface that may receive the projected interactive image.

It will be appreciated that, although specific embodiments have been described herein for purposes of illustration, various modifications may be made without departing from the spirit and scope of the embodiments. Accordingly, the scope of protection of these embodiments is limited only by the following claims and their equivalents.

What is claimed is:

1. A method comprising:
receiving an image to be projected onto a secondary surface;
measuring a distance from projection origination to the secondary surface;
measuring orientation of the projection origination with respect to the secondary surface;
calculating image geometry and image location in a projection area proximal to the secondary surface, the calculation based on the measured orientation of the projection origination and the measured distance, including calculating any corrections to a geometry of the image; and
applying the correction, the application creating a corrected image projection on the secondary surface.

2. The method of claim 1, further comprising observing the projected image on the secondary surface, including calculating an image correction based on the observed image and applying the image correction to the corrected image.

3. The method of claim 2, wherein the observation of the image projection is offset from the projection origination.

4. The method of claim 2, wherein calculating the image correction based on the observed image further comprises:
measuring pixel distance between a corner location of the projected image and a calculated corner location;
determining spatial distance based on the measured pixel distance between the projected image corner location and the calculated corner location; and
calculating the corrected image utilizing the determined spatial distance.

5. The method of claim 4, wherein calculating the image correction includes resolving any distortions of the corrected image.

6. The method of claim 1, further comprising measuring optical flow associated with the secondary surface, and utilizing the measured optical flow to determine a three-dimensional position of the projection origination.

7. The method of claim 1, further comprising stabilizing the projected image and interacting with the stabilized projected image, the interaction includes selecting indicia within the projected image.

8. The method of claim 7, wherein stabilizing includes updating the projected image, including applying a correction to the projected image based on a condition selected from the group consisting of: movement of the projection origination and a changed orientation of the projection origination.

9. The method of claim 7, wherein selecting indicia within the projected image includes:
aligning the projection origination with respect to the indicia;
orienting the projection origination with respect to the indicia; and
in response to receiving a selection input, observing the projected image and determining the indicia based on the alignment, orientation and observed projected image.

10. The method of claim 7, further comprising:
comparing the selected indicia to a parameter of the projected image; and
storing results of the comparison.

11. The method of claim 10, further comprising;
measuring a time interval between projection of the corrected image onto the secondary surface and selection within the projected image;
comparing the measured time interval to a predefined time interval; and
storing results of the comparison.

12. A system comprising:
a processing unit in communication with memory configured to receive an image to be projected onto a secondary surface;
a rangefinder operatively coupled to the processing unit and configured to measure a distance from projection origination to the secondary surface;
an orientation unit operatively coupled to the processing unit configured to measure orientation data of the projection origination;
a tool in communication with the processing unit and configured to:
calculate image geometry and image location with respect to a projection area proximal to the secondary surface, the calculation based on the measured orientation of the projection origination and the measured distance, including calculating a correction to a geometry of the image; and
create a corrected image, including application of the correction; and
a projector operatively coupled to the processing unit and configured to project the corrected image onto the secondary surface.

13. The system of claim 12, further comprising:
an image sensor configured to observe the corrected image projection on the secondary surface; and
the tool to:
calculate an image correction based on the observed image; and
apply the image correction to the corrected image; and
the projector to project the corrected image.

14. The system of claim 13, wherein the image sensor is offset from the projector.

15. The system of claim 13, wherein the tool calculates the image correction based on the observed image, the calculation further comprising:
measurement of pixel distance between a corner location of the projected image and a calculated corner location;
spatial distance determination based on the measured pixel distance between the projected image corner location and the calculated corner location; and
calculation of the corrected image based on the determined spatial distance.

16. The system of claim 15, wherein the calculation of the image correction includes resolution of any distortions of the corrected image.

17. The system of claim 12, further comprising:
an image sensor configured to measure optical flow associated with the secondary surface,
the tool to utilize the measured optical flow to determine a three-dimensional position of the projection origination.

18. The system of claim 12, further comprising the tool to:
stabilize the projected image;
respond to an interaction with the stabilized projected image, the interaction includes selection of indicia within the projected image.

19. The system of claim 18, wherein stabilization includes the tool to update the corrected image including application of the correction to the projected image based on a condition selected from the group consisting of: movement of the projection origination and a changed orientation of the projection origination.

20. The system of claim 18, wherein selection of indicia within the image includes:
alignment of the projection origination with respect to the indicia;
orientation of the projection origination with respect to the indicia; and
observation of the projected image by an image sensor in response to receiving a selection input; and
the tool to determine the indicia selection based on the alignment, orientation, and observation.

21. The system of claim 18, further comprising the tool to:
compare the selected indicia to a parameter of the projection image and store results of the comparison.

22. The system of claim 21, further comprising the tool to:
measure a time interval between projection of the corrected image onto the secondary surface and selection within the projected image;
compare the measured time interval to a predefined time interval; and
store results of the comparison.

23. A computer program product for projecting and interacting with an image, the computer program product comprising a computer readable storage device having program code embodied therewith, the program code executable by a processor to:
receive an image to be projected onto a secondary surface;
measure a distance from projection origination to the secondary surface;
measure orientation of the projection origination with respect to the secondary surface;
calculate image geometry and image location in a projection area proximal to the secondary surface, the calculation based on the measured orientation of the projection origination and measured distance, including calculation of any corrections to a geometry of the image; and
apply the correction, the application to create a corrected image projection on the secondary surface.

24. The computer program product of claim 23, further comprising program code to observe the projected image on the secondary surface, including calculate an image correction based on the observed image and apply the image correction to the corrected image.

25. The computer program product of claim 24, wherein the observation of the image projection is offset from the projection origination.

26. The computer program product of claim 24, wherein the calculation of image correction based on the observed image comprises program code to:
measure pixel distance between a corner location of the projected image and a calculated corner location;
determine spatial distance based on the measured pixel distance between the projected image corner location and the calculated corner location; and
calculate the corrected image utilizing the determined spatial distance.

27. The computer program product of claim 26, wherein the calculation of image correction includes program code to resolve any distortions of the corrected image.

28. The computer program product of claim 23, further comprising program code to:
measure optical flow associated with the secondary surface; and
determine a three-dimensional position of the projection origination based on the measured optical flow.

29. The computer program product of claim 23, further comprising computer program code to:
stabilize the projected image; and
interact with the stabilized projected image, the interaction includes selecting indicia within the projected image.

30. The computer program product of claim 29, wherein stabilization includes program code to:
update the projected image, including apply the correction to the projected image based on a condition selected from the group consisting of: movement of the projection origination and a changed orientation of the projection origination.

31. The computer program product of claim 29, wherein selection of indicia within the image includes:
alignment of the projection origination with respect to the indicia;
orientation of the projection origination with respect to the indicia; and
program code to respond to receiving a selection input and program code to observe the projected image and determine the indicia selection based on the alignment, orientation and observed projected image.

32. The computer program product of claim 29, further comprising program code to:
compare the selected indicia to a parameter of the projected image; and
store results of the comparison.

33. The computer program product of claim 32, further comprising program code to:
measure a time interval between projection of the corrected image onto the secondary surface and selection within the projected image;
compare the measured time interval to a predefined time interval; and
store results of the comparison.
